(19) United States
(12) Patent Application Publication
(10) Pub. No.: US 2026/0085777 A1
(43) Pub. Date: Mar. 26, 2026

(54) Assembly Capable of Effectively Sealing Non-Metallic Tube Body

(71) Applicant: LI CHUNG PLASTICS INDUSTRY CO., LTD., TAICHUNG CITY (TW)

(72) Inventor: Tony HSU, TAICHUNG CITY (TW)

(21) Appl. No.: 18/892,036

(22) Filed: Sep. 20, 2024

(51) Int. Cl. F16L 33/22; F16L 33/18

(52) U.S. Cl. CPC F16L 33/24

(57) ABSTRACT

A assembly for sealing a non-metallic tube includes a rotating part, which is a columnar body having a channel, and both ends defined as a first end and a second end. The rotating part has a drilling portion, an bite portion, a fill portion and a linking portion sequentially arranged on the outer side from the first end to the second end; the first end is socketed into an end of a tube by the drilling portion; the bite portion is a spiral concave groove on an outer side of the rotating part for biting and attaching an inner side of the tube; the fill portion is between an end of the tube and the linking portion for sealing an opening of the tube; and the linking portion is between the fill portion and the second end and exposed from the tube for connecting another linking portion of another assembly.

### FIELD OF INVENTION

The present invention relates to an assembly, and more particularly to the assembly capable of effectively sealing non-metallic tube body.

### BACKGROUND OF INVENTION

### Description of the Related Art

A pipeline such as a rubber tube or a plastic tube used for transmitting a fluid usually requires a connector to connect a device or another pipeline, and the pipeline is cut into an appropriate length according to actual requirements and then a connector is installed to an end of the pipeline.

With reference to FIG. 9 for a conventional connector, an end of a tube 91 such as a rubber tube or a plastic tube is passed and sheathed to the interior of a metal sheath 92, and then an end of a hollow columnar plug 93 is passed into the tube 91, and a mechanical equipment or a hydraulic equipment applies a tightening pressure to the metal sheath 92 to tightly clamp the tube 91 between the metal sheath 92 and the plug 93, and a linking portion 931 such as an external thread disposed at the other end of the plug 93 is provided for connecting an internal thread of another connector.

With reference to FIG. 10 for another conventional connector, the difference between this connector and the previous one as shown in FIG. 10 resides on that the linking portion 931 at the other end of the plug 93 has a nut, and an end of the nut is pivotally connected to the plug 93 for connecting an external thread of another connector.

The aforementioned conventional connector requires a mechanical equipment or hydraulic equipment that applies a tightening pressure to the metal sheath 92 to achieve a watertight or airtight effect.

In the aforementioned conventional connector, full inspection must be performed, in terms of quality control, to ensure the watertight or airtight effect of the plug 93 and the tube 91 due to the problems of the connection strength of the plug 93 that is connected to the tube 91 or the tolerance of the tightening equipment. It is not just laborious and time-consuming only, but also involves a tightening process that will reduce the space of the channel of the plug 93.

Please refer to FIG. 11. Further, the inventor of the present invention has invented an improved structure, wherein a circular member is formed and extended in a transverse direction from an inner side of an end of the metal sheath 92 for abutting and connecting a surface of the circular member by an outer end surface of the tube 91, and the inner side of the circular member further has a triangular internal thread 921, and an end of the plug 93 has a triangular external thread 932. By the triangular (V style) internal thread 921 and the external thread 932, a wrench can be used to rotate the plug 93, and the plug 93 can be guided into the tube 91 more easily, and the external thread 932 of the plug 93 can be used to embedding and engaging the inner side of the tube 91. In general, if the inner diameter of the tube 91 is 6.5 mm, the outer diameter of the external thread 932 of the plug 93 must be approximately 9.6 mm to achieve the embedment or engagement with a watertight or airtight effect. The material used for embedding and engaging the tube 91 is generally not longer than 0.5 mm, and the tensile strength of the plug 93 is approximately 60 kg.

However, in this improved structure having the metal sheath 92 with the internal thread 921 and the plug 93 with the external thread 932, the connection strength of the plug 93 that is embedded and engaged with the tube 91 still does not reach the desired resistance strength. In addition, when the triangular external thread 932 of the plug 93 enters into the tube 91, they are often misaligned, thus resulting in poor embedment and engagement. On the other hand, when the bending position of the tube 91 is always adjacent to the metal sheath 92 and the plug 93, in order to prevent the tube 91 from contacting the plug 93 and causing rupture, a protective sleeve 94 is used. The sleeve 94 corresponds to the metal sheath 92 and the plug 93 and is fitted outside the tube 91 so that the bending position of the tube 91 will not be adjacent to one end of the metal sheath 92 or the plug 93.

### SUMMARY OF THE INVENTION

Therefore, it is a primary object of the present invention to provide an assembly capable of effectively sealing non-metallic tube body, and the assembly can be installed to a tube or a device instantly and conveniently.

Another objective of the present invention is to provide an assembly capable of effectively sealing non-metallic tube body, and the assembly can achieve a watertight or airtight effect easily.

A further objective of the present invention is to provide an assembly capable of effectively sealing non-metallic tube body, and the assembly can lower the assembling cost effectively.

To achieve the aforementioned and other objectives, the present invention discloses an assembly capable of effectively sealing non-metallic tube body, and the assembly comprises a rotating part which is a columnar body having a channel and both ends defined as a first end and a second end respectively, and an outer side of the rotating part has a drilling portion, an bite portion, a fill portion and a linking portion sequentially arranged from the first end to the second end; wherein, the first end of the rotating part is passed and socketed into an end of a tube by the drilling portion; the bite portion is a spiral concave groove disposed on an outer side of the rotating part for biting and attaching an inner side of the tube; the fill portion is disposed between an end of the tube and the linking portion for sealing an opening of the tube to stop leaking a fluid of the tube; and the linking portion is disposed between the fill portion and the second end of the rotating part and exposed from the tube, and the linking portion is provided for coupling another linking portion of another assembly.

The above and other objects, features and advantages of the invention will become apparent from the following detailed description taken with the accompanying drawings.

### BRIEF DESCRIPTION OF THE DRAWINGS

FIG. 1 is a perspective view showing an assembly of a tube and an bundle-protection socket in accordance with a first preferred embodiment of the present invention;

FIG. 2 is an exploded view of FIG. 1;

FIG. 3 is a cross-sectional view of Section 3-3 of FIG. 1;

FIG. 4 is a perspective view showing an assembly of a tube and an bundle-protection socket in accordance with a second preferred embodiment of the present invention;

FIG. 5 is an exploded view of FIG. 4;

FIG. 6 is a cross-sectional view of Section 6-6 of FIG. 4;

FIG. 7 is a schematic view showing the assembly of FIG. 4 without the design of a hexagonal profile but having a screw for assembling a tube and an bundle-protection socket;

FIG. 8 is a perspective view showing an assembly of a tube and an bundle-protection socket in accordance with a third preferred embodiment of the present invention;

FIG. 9 is a perspective view showing an assembly of a tube and a metal sheath of a conventional connector;

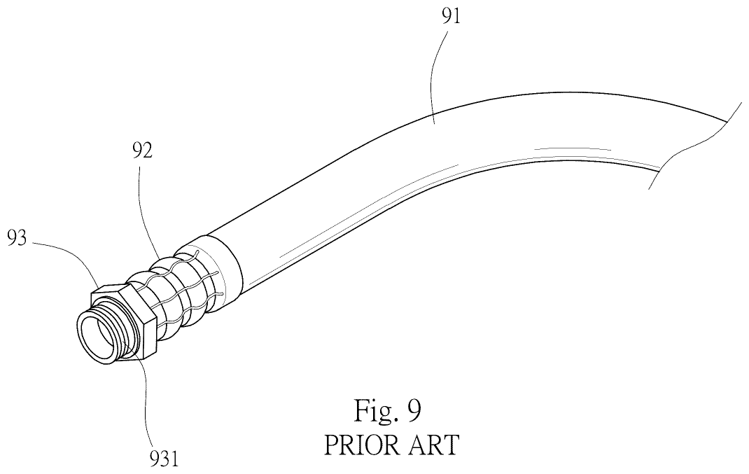

FIG. 10 is another perspective view showing an assembly of a tube and a metal sheath of a conventional connector; and

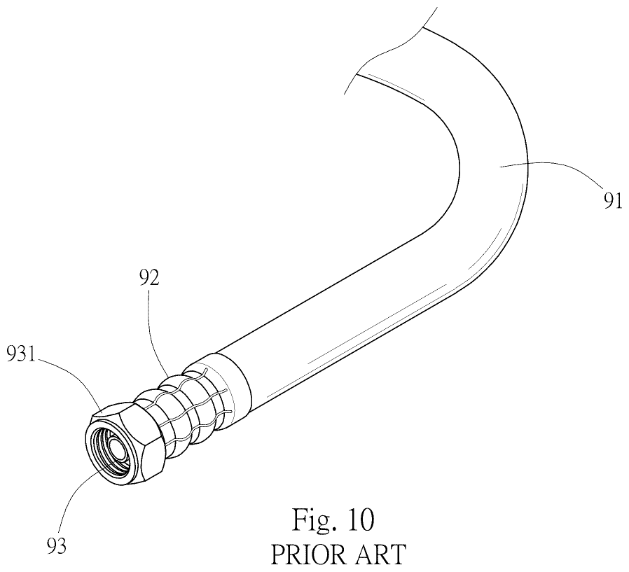

FIG. 11 is perspective view showing an assembly of a tube, a metal sheath and a protective sleeve of a conventional connector.

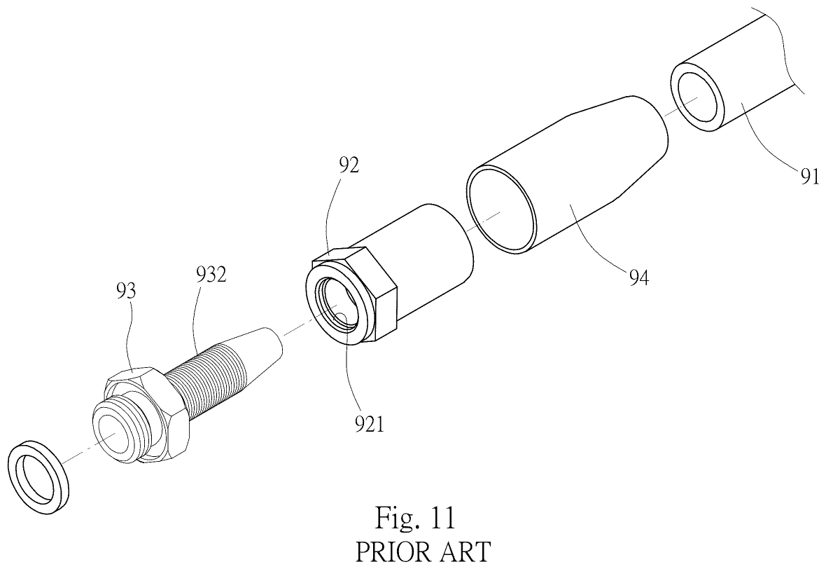

### DESCRIPTION OF THE PREFERRED EMBODIMENTS

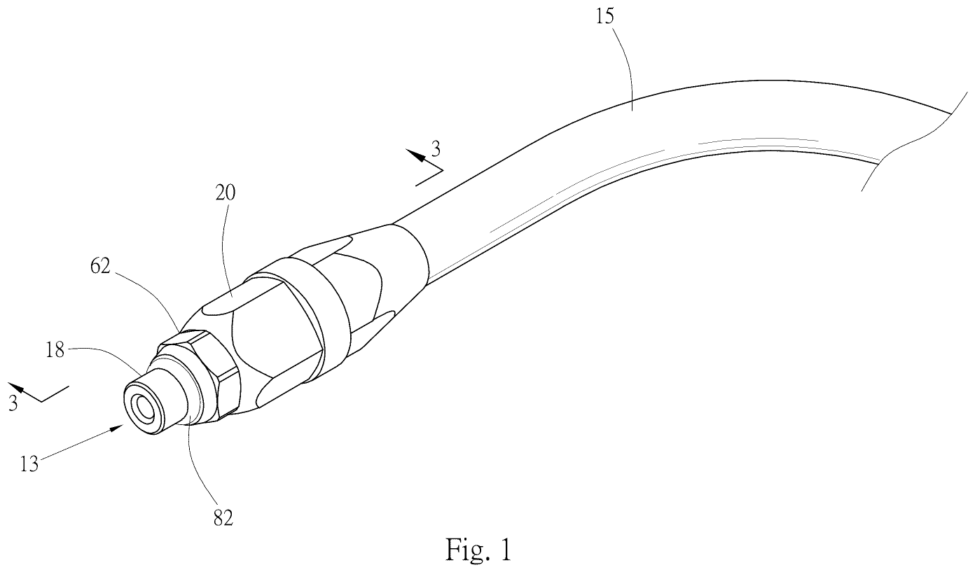

With reference to FIGS. 1 to 3 for an assembly capable of effectively sealing non-metallic tube body in accordance with the first embodiment of the present invention, the assembly includes a rotating part 10 which is a columnar body having a first channel and both ends defined as a first end 11 and a second end 13 respectively, and an outer side of the rotating part 10 has a drilling portion 12, an bite portion 14, a fill portion 16 and a linking portion 18 sequentially arranged from the first end 11 to the second end 13.

The first end 11 of the rotating part 10 is partially socketed into an interior of an end of a tube 15 by a rotation of the drilling portion 12, and the drilling portion 12 is a conical body with a size of the outer side of the rotating part 10 decreasing in a direction from a side of the bite portion 14 to the first end 11. By the conical drilling portion 12, the rotating part 10 has be better degree of freedom to pass and sheath to the interior of the tube 15, wherein the tube 15 can be a rubber tube, a plastic tube or a silicone tube. The tube 15 can also be made of any mixture or combination of rubber, plastic and silicone.

The bite portion 14 is a spiral concave groove formed on the outer side of the rotating part 10. One end of the bite portion 14 is neighbor to the drilling portion 12. When the rotating part 10 is rotatably passed and sheath to the interior of the tube 15, the spiral concave groove of the bite portion 14 is provided for embedding, biting, attaching and connecting an inner side of the tube 15 to achieve the effect of engaging the rotating part 10 with the tube 15. Particularly, if the size of the bite portion 14 is greater than the size of an internal space of the tube 15, then the present invention further has a locking and biting effect, wherein the spiral concave groove of the bite portion 14 can be a trapezoidal thread or a rectangular thread. A maximum outer diameter of the bite portion 14 is a hollow diameter of the tube 15 plus 1.5 mm. A minimum outer diameter of the bite portion 14 is the hollow diameter of the tube 15 plus 1.0 mm.

The fill portion 16 is formed by an appropriate part extending in a direction from other side of the bite portion 14 to the second end 13, and the fill portion 16 is a columnar body with an outer side in a shape corresponding to a shape of the internal space of the tube 15 and an outer diameter being at least equal to the outer diameter of the bite portion 14 or the hollow diameter of the tube 15 for attaching the inner side of the tube 15. When the rotating part 10 is rotatably passed and sheathed to the interior of the tube 15, the fill portion 16 is provided for attaching and connecting the inner side of the tube 15 to seal an opening of the tube 15, so as to achieve the effect of preventing a fluid in the tube 15 from leaking from a surrounding of the rotating part 10.

The linking portion 18 is disposed between the fill portion 16 of the rotating part 10 and the second end 13 and exposed from the tube 15, and the linking portion 18 is provided for connecting another linking portion of another assembly (not shown in the figures). When the linking portion 18 is an external thread, another linking portion of another assembly can be an internal thread such as a nut. Further, an anti-leakage washer 82 can be installed between the linking portion 18 and the rotating part 10 for sealing an opening of another assembly to achieve the anti-leakage effect.

In FIGS. 1 to 3, the assembly capable of effectively sealing non-metallic tube body of the present invention further includes an bundle-protection socket 20 which is a columnar body having a second channel and socketed and attached to an outer side of the end of the tube 15, an inner edge shape of the second channel corresponds to an outer shape of the cylinder of the tube 15, so that the end of the tube 15 is at least attached between the bundle-protection socket 20 and the bite portion 14 of the rotating part 10, and the bundle-protection socket 20 is provided for strengthening the assembly structure of the rotating part 10 and the tube 15. Wherein, an inner diameter of the bundle-protection socket 20 is at least equal to an outer diameter of the tube 15. A length of the bundle-protection socket 20 is at least greater than a combined length of the drilling portion 12, the bite portion 14 and the fill portion 16, so as to effectively prevent the tube 15 from being damaged due to frequent bending.

In the assembly capable of effectively sealing non-metallic tube body as shown in FIGS. 1 to 3, a hexagonal member 62 is extended from the outer side of the rotating part 10 and between the fill portion 16 and the linking portion 18, so that the present invention can use a wrench to apply a force to the hexagonal member 62 in order to install the assembly to the tube 15 instantly and conveniently.

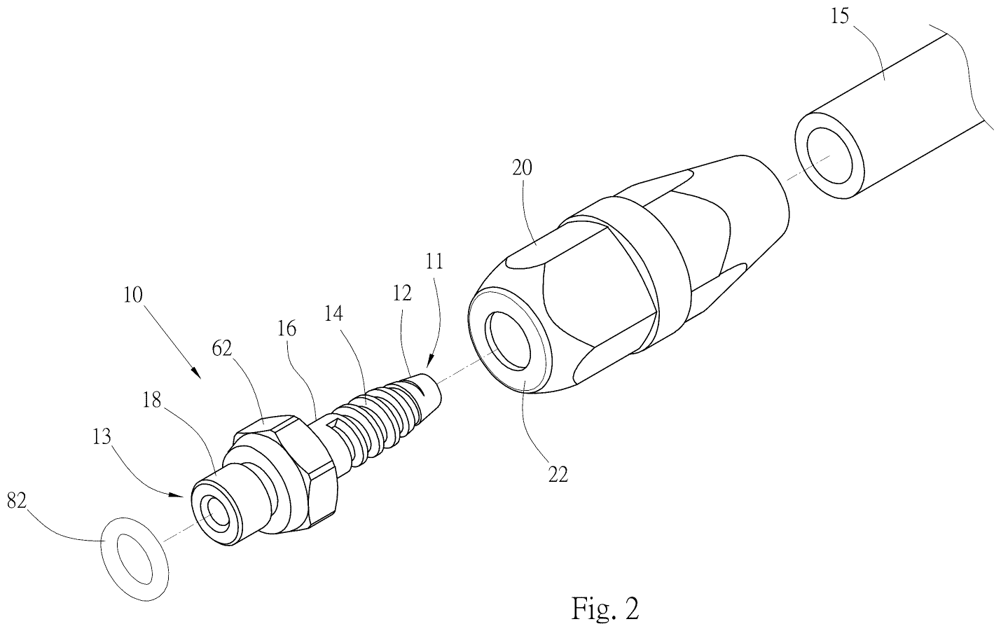

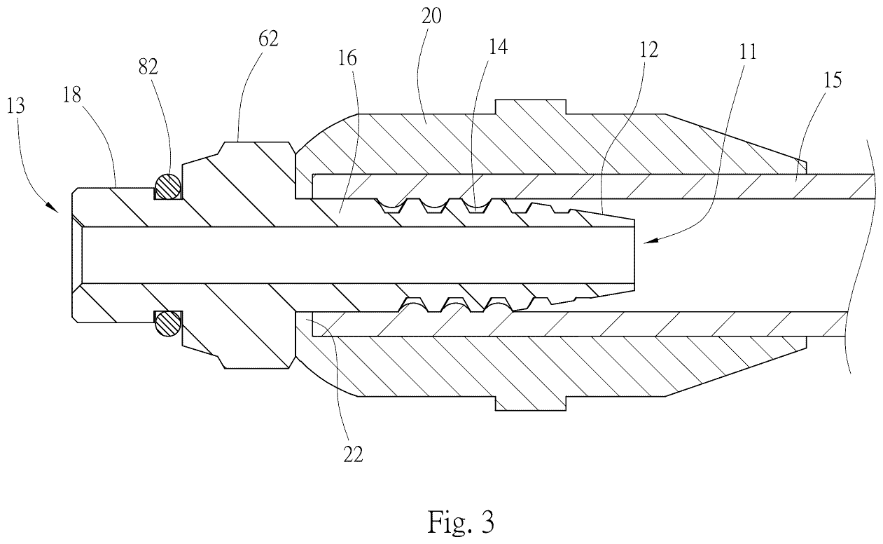

In the assembly capable of effectively sealing non-metallic tube body of the present invention as shown in FIGS. 2 and 3, a circular member 22 is extended in a transverse direction from an inner side of an end of the bundle-protection socket 20, so that an outer end surface of the tube 15 can abut and connect a side of the circular member 22 to provide better structural strength and assembly positioning.

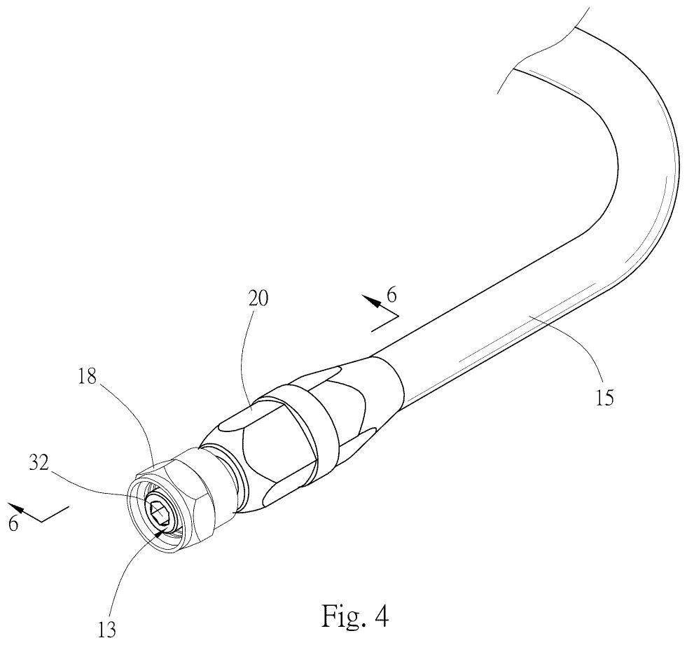

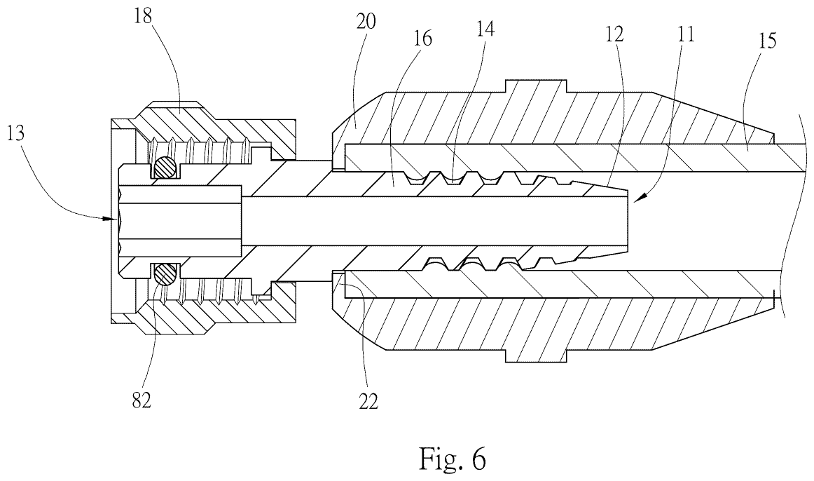

With reference to FIGS. 4 to 6 for an assembly capable of effectively sealing non-metallic tube body in accordance with the second embodiment of the present invention, the linking portion 18 is a columnar body having a third channel, and the linking portion 18 has an end pivotally connected to the rotating part 10 and other end of the linking portion 18 has an internal thread for connecting another assembly, and another linking portion of another assembly can be an external thread. The linking portion 18 of the second embodiment of the present invention is a nut.

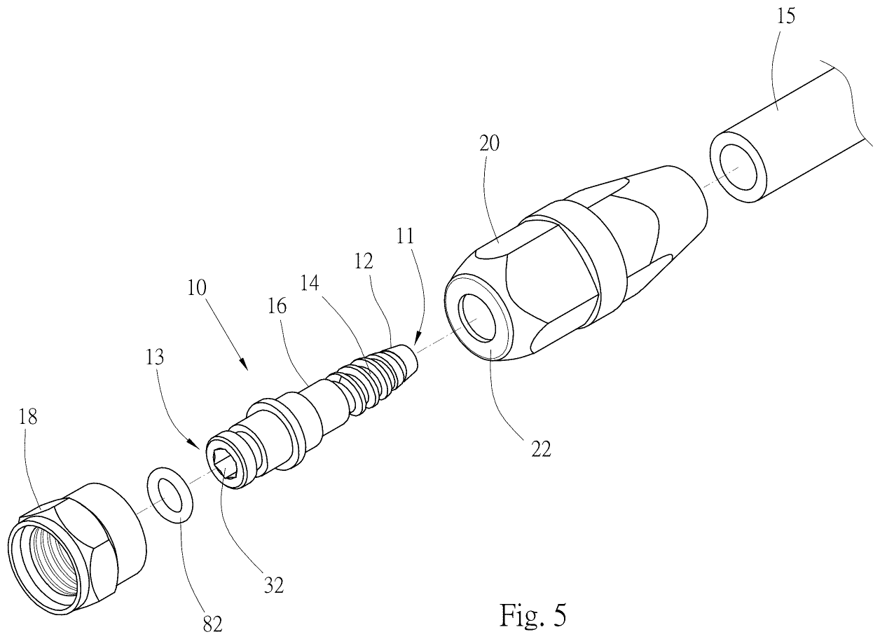

In the assembly capable of effectively sealing non-metallic tube body of the present invention as shown in FIGS. 4 and 5, a hexagonal profile 32 is designed on an inner side of the second end 13 of the rotating part 10, and the present invention can use an Allen wrench to apply a force to the hexagonal profile 32 in order to install the assembly to the tube 15 instantly and conveniently.

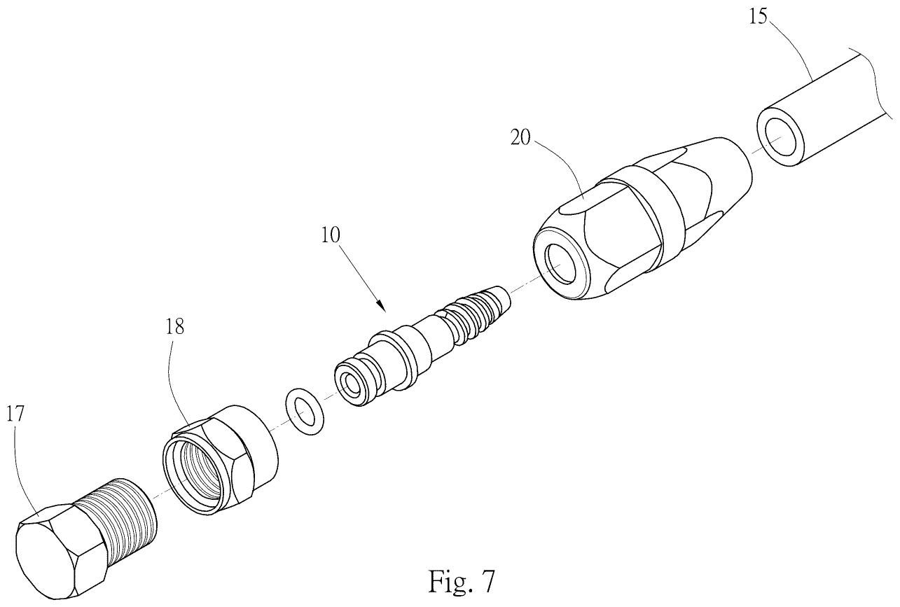

With reference to FIG. 7, if the second embodiment of the present invention does not have the design of the hexagonal profile 32, then the present invention can be used together with a screw 17 to lock the linking portion 18, so as to link the rotating part 10 to install the assembly to the tube 15 instantly and conveniently.

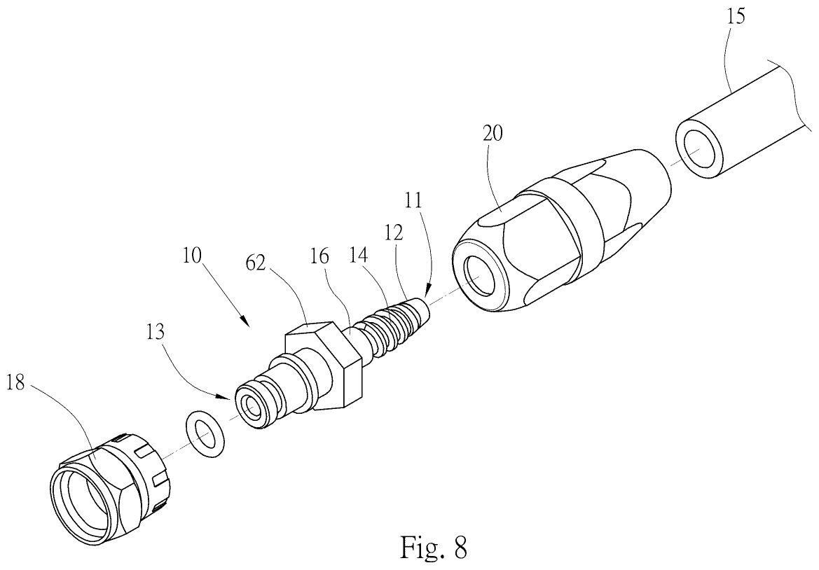

With reference to FIG. 8 for the third embodiment of the present invention, if the second embodiment of the present invention does not have the design of the hexagonal profile 32, then a hexagonal member 62 can be designed on the outer side of the rotating part 10 and between the fill portion 16 and the linking portion 18, so that the present invention can use a wrench to apply a force to the hexagonal member 62 to install the assembly to the tube 15 instantly and conveniently.

In the present invention, the spiral concave groove of the bite portion 14 can be designed as the trapezoidal thread or the rectangular thread to significantly enhance the connection strength for the embedment and engagement of the rotating part 10 with the inner side of the tube 15, and the material of the rotating part 10 embedding and engaging with the tube 15 can be up to 0.75˜1.0 mm, and the tensile strength of the rotating part 10 is approximately 120˜200 kg, so that the present invention can almost or completely achieve the watertight and airtight effect. In addition, the spiral concave groove of the rotating part 10 having an outer diameter of only 8 mm is provided for passing through the tube 15 having an inner diameter of 6.5 mm, so that the present invention can achieve the aforementioned effects. On the other hand, when the spiral concave groove of the rotating part 10 is passed through the tube 15, the rotating part 10 has a self-guiding effect to prevent misalignment. The present invention further provides the design of the fill portion 16, so that the assembly of the present invention can achieve the watertight or airtight effect more effectively and reliably without requiring any tightening mechanical equipment or requiring the installation of the bundle-protection socket 20, and the invention does not require full inspection for the quality control. In other words, while the outer diameter of the fill portion 16 can be equal to or greater than the inner diameter of the tube 15, the present invention can achieve the better watertight or airtight effect.

In the present invention, the bite and contact of the sandwich structure formed by the rotating part 10, the tube 15 and the bundle-protection socket 20 greatly enhances the connection strength. In addition, this invention integrates the conventional metal sheath and protective sleeve into a single component. The bundle-protection socket 20 effectively reduces manufacturing costs.

As to the manufacture of the assembly of the present invention, the manufacturing process can be divided into different assembly processes to effectively achieve a manufacture with division of labor, and the present invention has a better production efficiency to effectively lower the manufacturing cost.

What is claimed is:

1. A assembly capable of effectively sealing non-metallic tube body, comprising:
a tube, being a hollow cylinder having an appropriate length, and having a material being selected from a group consisting of rubber, plastic, silicone and any combination thereof;
a rotating part, being a columnar body having a first channel, and having both ends defined as a first end and a second end respectively, the rotating part having a drilling portion, a bite portion, a fill portion and a linking portion disposed on an outer side thereof and arranged sequentially in a direction from the first end to the second end;
wherein, the drilling portion is a conical body with a size of the outer side of the rotating part decreasing in a direction from a side of the bite portion to the first end;
the first end of the rotating part is partially socketed into an end of the tube by a rotation of the drilling portion;
the bite portion is cylinder and has a rectangular or trapezoidal thread disposed on an outer side of the rotating part for biting and attaching an inner side of the tube; a maximum outer diameter of the bite portion is a hollow diameter of the tube plus 1.5 mm; a minimum outer diameter of the bite portion is the hollow diameter of the tube plus 1.0 mm;
the fill portion is a cylinder, disposed between the end of the tube and the linking portion and with an outer diameter being at least equal to the hollow diameter of the tube for attaching the inner side of the tube and sealing an opening of the tube to stop leaking a fluid of the tube;
the linking portion is disposed between the fill portion and the second end of the rotating part and exposed from the tube, and the linking portion is provided for coupling another linking portion of another assembly; and
a bundle-protection socket, being a columnar body having a second channel and socketed and attached to an outer side of the end of the tube, wherein, an inner edge shape of the second channel corresponds to an outer shape of the cylinder of the tube, so that the end of the tube is at least attached between the bundle-protection socket and the bite portion of the rotating part, an inner diameter of the bundle-protection socket is at least equal to an outer diameter of the tube, and a length of the bundle-protection socket is at least greater than a combined length of the drilling portion, the bite portion and the fill portion.

2. The assembly capable of effectively sealing non-metallic tube body according to claim 1, wherein the linking portion is an external thread.

3. The assembly capable of effectively sealing non-metallic tube body according to claim 1, wherein the linking portion is a columnar body having a third channel, and the linking portion has an end pivotally coupled to the rotating part and other end having an internal thread for coupling another assembly.

4. The assembly capable of effectively sealing non-metallic tube body according to claim 2, further comprising an anti-leakage washer installed between the linking portion and the rotating part for sealing an opening of another assembly.

5. The assembly capable of effectively sealing non-metallic tube body according to claim 3, further comprising an anti-leakage washer installed between the linking portion and the rotating part for sealing an opening of another assembly.

6. The assembly capable of effectively sealing non-metallic tube body according to claim 1, wherein the rotating part has a hexagonal member extending from the outer side thereof and between the fill portion and the linking portion, or a hexagonal profile formed on an inner side of the second end of the rotating part.

7. The assembly capable of effectively sealing non-metallic tube body according to claim 2, wherein the rotating part has a hexagonal member extending from the outer side thereof and between the fill portion and the linking portion, or a hexagonal profile formed on an inner side of the second end of the rotating part.

8. The assembly capable of effectively sealing non-metallic tube body according to claim 3, wherein the rotating part has a hexagonal member extending from the outer side thereof and between the fill portion and the linking portion, or a hexagonal profile formed on an inner side of the second end of the rotating part.

9. The assembly capable of effectively sealing non-metallic tube body according to claim 4, wherein the rotating part has a hexagonal member extending from the outer side thereof and between the fill portion and the linking portion, or a hexagonal profile formed on an inner side of the second end of the rotating part.

10. The assembly capable of effectively sealing non-metallic tube body according to claim 5, wherein the rotating part has a hexagonal member extending from the outer side thereof and between the fill portion and the linking portion, or a hexagonal profile formed on an inner side of the second end of the rotating part.

11. The assembly capable of effectively sealing non-metallic tube body according to claim 1, wherein a circular member is extended in a transverse direction from an inner side of an end of the bundle-protection socket, so that an outer end surface of the tube can abut and connect a side of the circular member.

12. The assembly capable of effectively sealing non-metallic tube body according to claim 2, wherein a circular member is extended in a transverse direction from an inner side of an end of the bundle-protection socket, so that an outer end surface of the tube can abut and connect a side of the circular member.

13. The assembly capable of effectively sealing non-metallic tube body according to claim 3, wherein a circular member is extended in a transverse direction from an inner side of an end of the bundle-protection socket, so that an outer end surface of the tube can abut and connect a side of the circular member.

14. The assembly capable of effectively sealing non-metallic tube body according to claim 4, wherein a circular member is extended in a transverse direction from an inner side of an end of the bundle-protection socket, so that an outer end surface of the tube can abut and connect a side of the circular member.

15. The assembly capable of effectively sealing non-metallic tube body according to claim 5, wherein a circular member is extended in a transverse direction from an inner side of an end of the bundle-protection socket, so that an outer end surface of the tube can abut and connect a side of the circular member.
